(19) United States
(12) Patent Application Publication
(10) Pub. No.: US 2005/0284819 A1
(43) Pub. Date: Dec. 29, 2005

(54) Fluid clarification system

(75) Inventor: Charles E. Leffler, Lake Worth, FL (US)

Correspondence Address: AKERMAN SENTERFITT, P.O. BOX 3188, WEST PALM BEACH, FL, 33402-3188, US

(73) Assignee: Marine Environmental Partners, Inc., West Palm Beach, FL (US)

(21) Appl. No.: 11/127,900

(22) Filed: May 12, 2005

Related U.S. Application Data
(60) Provisional application No. 60/570,236, filed on May 12, 2004.

(51) Int. Cl. C02F 1/24

(52) U.S. Cl. 210/703; 210/221.2

(57) ABSTRACT

A fluid clarification system for removing at least a portion of the contaminants, which may be, but are not limited to, suspended solids, from a fluid. The fluid may be mixed with one or more ionized gases in a clarification tank. The clarification tank may be configured to prevent spillage of fluid from the containment tank.

### CROSS REFERENCE TO RELATED APPLICATION

The invention claims the benefit of U.S. Provisional Application No. 60/570,236, filed May 12, 2004.

### FIELD OF THE INVENTION

The invention is directed generally to waste water treatment systems, and more particularly, to waste water treatment systems that use gases to facilitate removal of contaminants from contaminant laden fluid.

### BACKGROUND

There exist many different types of waste water treatment systems for cleaning waste waters such as, municipal wastes, industrial wastes, and the like. Some such systems use air bubbles to facilitate removal of contaminants from a fluid. One particular system that uses air bubbles to remove contaminants from a fluid is a dissolved air flotation unit (DAF). Conventional DAFs are often formed from a clarification tank having one or more injectors for injecting a gas, which is often air, into the fluid contained in the clarification tank. Bubbles formed from the gas carries contaminants to the surface of the fluid. The clean fluids may be removed from the middle aspects of the tank, which is the region above the collection of contaminants on the floor of the clarification tank and below the collection of floating contaminants.

Some conventional DAFs use a single weir positioned in a clarification tank for controlling the flow of fluids in the DAFs. The weir controls the fluid flow and separate clean water from contaminants that collect on the bottom of the clarification tank. More specifically, some contaminants precipitate out of the fluid and collect at the bottom of the clarification tank before the fluid passes over the weir. While these conventional DAF systems remove contaminants from fluids, these systems often must be used in conjunction with other systems to achieve a desired level of contaminant removal from a fluid. Thus, a need exists for a DAF having superior contaminant removal capabilities.

### SUMMARY OF THE INVENTION

This invention is directed to a fluid clarification system for removing at least a portion of a total concentration of contaminants from a contaminant laden fluid, such as, but not limited to, water. The fluid clarification system may inject one or more gases into the fluid to facilitate removal of the contaminants from the fluid. In at least one embodiment, the fluid clarification may inject ionized gases into the fluid. The gases form microbubbles in a clarification tank that carry contaminants to an upper surface of the fluid contained in the clarification tank, where the contaminants may be easily removed from the surface of the fluid.

In at least one embodiment, the fluid clarification system may be formed from a clarification tank configured to contain a contaminant laden fluid having suspended solids. The clarification tank may have an inlet for injecting a gas into the tank and an outlet for withdrawing cleansed fluid from the tank. The fluid clarification system may include a vacuum system for drawing contaminants from an upper surface of the fluids contained in the clarification tank. The clarification tank may include a standpipe with one or more apertures for regulating the flow of fluids from the tank through the outlet. A recirculating loop may facilitate cleansing of the fluids contained in the clarification tank.

In one embodiment, the system may include a floating head that may be slidably attached to the clarification tank to enable the floating head to move generally along a longitudinal axis of the clarification tank to float on an upper surface of a fluid contained in the clarification tank. The fluid clarification system may also include one or more rake arms for drawing contaminants from the upper surface of the fluid contained in the clarification tank.

A saturator may be included upstream of the clarification tank. The saturator may be adapted to inject ionized gas, or other disinfectant, into the fluid flowing through the saturator while the fluid is under pressure. One or more contact tanks may be positioned downstream from the clarification tank for increasing the amount of time that the disinfectants may be in contact with the fluid. In addition, one or more disinfectants may be added to the fluid in the contact tanks. Disinfectants may also be to the clarification tank.

In operation, fluids may be injected into the clarification tank through an inlet. In embodiments having a saturator, ionized gas may be injected into the contaminant laden fluid in the saturator. As the fluids enter the clarification tank, the ionized gas that has saturated the fluid at a pressurized condition in the saturator is released as many microbubbles. The microbubbles rise to the surface of the fluid contained in the clarification tank and cause contaminants in the fluid to collect on the surface. The contaminants are removed from the surface with the vacuum system. Processed fluid may be removed through the standpipe, passed through the outlet and on to other systems. In at least one embodiment, the processed fluid may be passed to one or more contact tanks where the fluid may be placed in contact with disinfectants. In at least one embodiment, the fluid may be tested to determine whether a concentration of contaminants is beneath a particular threshold. If the concentration is above the threshold, the fluids may be sent through the recirculation loop to the beginning of the system for additional processing. Otherwise, the processed fluid may be discharged from the system.

The fluid clarification system is particularly well suited for use on vessels. In situations where a vessel encounters wave action, the floating head and rake arm can advantageously tilt relative to a longitudinal axis of the clarification tank enabling the rake arm to stay at the upper surface of the fluid in the clarification tank and collect floating contaminants. In addition, the floating head is able to tilt with a vessel and act as a cap for the clarification tank. Furthermore, the embodiment having the standpipe configuration is well suited to use on vessels in heavy seas. In particular, the standpipe limits the flow of fluids through the outlet during heavy sea conditions by limiting the flow of fluids through the at least one aperture, which may be a slot in at least one embodiment. In addition, the clarification tank may include a domed lid that is configured to prevent fluids from escaping during heavy sea conditions. The domed lid may cooperate with the vacuum system to remove contaminants from the system. The clarification tank may also be configured to maintain a nearly full capacity with little air to limit movement of the fluids contained in the tank during heavy sea conditions.

These and other features and advantages of the present invention will become apparent after review of the following drawings and detailed description of the disclosed embodiments.

### BRIEF DESCRIPTION OF THE DRAWINGS

The accompanying drawings illustrate embodiments of this invention and, together with the description, disclose various aspects of the invention. These figures include the following:

FIG. 1 is schematic diagram a fluid clarification system including one or more aspects of this invention;

FIG. 2 is a front view of a clarification tank of this invention;

FIG. 3 is a top view of the clarification tank shown in FIG. 2;

FIG. 4 is a cross-sectional view of the clarification tank shown in FIG. 3 along section line 4-4.

FIG. 5 is a cross-sectional view of the clarification tank shown in FIG. 4 with a floating head and rake arm shown in a tilted position relative to a longitudinal axis.

FIG. 6 is a cross-sectional view of an alternative embodiment of the fluid clarification system having two clarification tanks coupled together in series.

### DETAILED DESCRIPTION

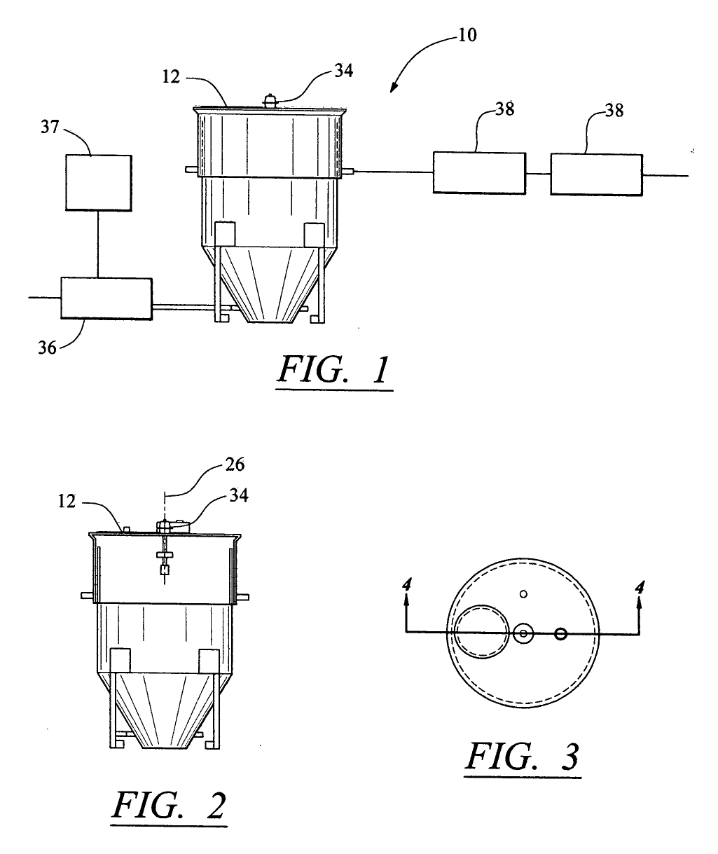

As shown in FIGS. 1-6, the invention is directed to a fluid clarification device 10 for removing contaminants from contaminant laden fluid. In at least one embodiment, the fluid clarification system 10 may be configured to remove contaminants, such as suspended solids. However, the fluid clarification system 10 may remove other contaminants as well, such as, but not limited to BOD, COD, metals, salts, nutrients, and others. The fluid clarification system 10 may mix one or more gases with a contaminant laden fluid to remove at least a portion of the contaminants. In at least one embodiment, one or more ionized gases may be injected into a contaminant laden fluid to facilitate removal of at least a portion of the contaminants. The fluid clarification system 10 may also be referred to as a modified dissolved air flotation unit (DAF) utilizing ionized air.

In at least one embodiment, as shown in FIG. 1, the fluid clarification system 10 may be formed from one or more clarification tanks 12 configured to mix one or more gases with one or more contaminant laden fluids. The clarification tank 12 may have any appropriate shape and configuration to perform this function. In at least one embodiment, as shown in FIG. 1, the clarification tank 12 may be generally cylindrical in shape with a tapered bottom and configured to process about 100 m³/day and in some embodiments may process up to about 600 tons per day. The clarification tank 12 may be formed from materials, such as, but not limited to, steel, such as stainless steel, aluminum, plastic, fiberglass, and other appropriate materials.

The clarification tank 12 may be formed from an inner chamber 14 and an outer chamber 16, whereby the inner chamber 14 may be positioned concentrically within the outer chamber 16. In one embodiment, the clarification tank 12 may include one or more conical baffles 17 positioned in lower regions of the clarification tank 12. The conical baffles 17 distribute fluid across the bottom of the tank 12 and reduce turbulence in the tank 12. Generally, the ability of the tank 12 to separate suspended particles from the fluid increases as turbulence in the fluid contained in the tank 12 is reduced. The clarification tank 12 may also include an inlet port 18 positioned proximate to a bottom surface 20 of the clarification tank 12. One or more baffles 22 may be positioned proximate to the inlet port 18 to assist in dispersing fluid entering the clarification tank 12 through the inlet port 18. An outlet port 19 may be coupled to the clarification tank 12 for removing fluids from the outer chamber. In at least one embodiment, the outlet port 19 may be positioned above the level at which the fluids enter the clarification tank 12 through the inlet port 18.

The fluid clarification system 10 may also include a floating head 24 configured to float on an upper surface of the fluid contained in the clarification tank 12. The floating head 24 is capable of tilting relative to a longitudinal axis 26 of the clarification tank 12. In at least one embodiment, as shown in FIG. 5, the floating head 24 is capable of tilting relative to the longitudinal axis 26 up to an angle α, which may be up to about 15 degrees. The tilting capability of the floating head 24 enables the floating head 24 to tilt when a vessel to which the fluid clarification system 10 is attached pitches due to wave action. The tilting capability of the floating head 24 keeps the head 24 properly positioned over the upper surface of the fluid and limits contact with the fluid. The floating head 24 prevents fluid contained in the clarification tank 12 from splashing out of the clarification tank 12.

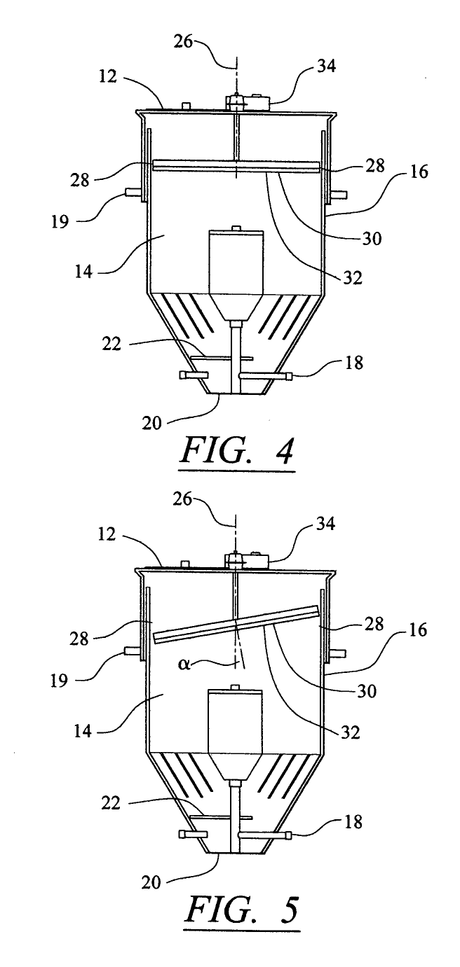

The floating head 24 may be slidably attached to the clarification tank 12 such that the floating head 24 may move along the longitudinal axis 26. In at least one embodiment, as shown in FIGS. 4 and 5, the floating head 24 may be attached to the clarification tank 12 using a plurality of rollers 28. The rollers 28 enable the floating head to be slidably attached to the walls forming the inner chamber 14.

The fluid clarification system 10 may also include one or more rake arms 30 rotatably attached to the floating head 24. For instance, the fluid clarification system 10 may include two or four rake arms in at least one embodiment. The rake arm 30 may be attached to the floating head such that the rake arm 30 may rotate generally at the surface of the fluid contained in the clarification tank 12 to remove contaminants that have floated to the surface of the fluid. The rake arm 30 may include one or more orifices 32 for collecting contaminants from the fluid by drawing the contaminants into the rake arm 30. In at least one embodiment, the rake arm 30 may be positioned generally orthogonal to the longitudinal axis 26 and may be formed from four rake arms 30. The rake arms 30 may be positioned substantially in a single plane and be positioned about 90 degrees apart. In other embodiments, the rake arm 30 may be positioned in a plane that is neither orthogonal nor parallel to the longitudinal axis 26; rather, the rake arm 30 may be at an angle of between about one degree and about 89 degrees relative to the longitudinal axis 26.

The fluid clarification system 10 may also include a vacuum 34 for removing contaminants from the fluid contained in the clarification tank 12 by drawing contaminants through the rake arm 30. The vacuum 34 may be in communication with the rake arm 30 through the floating head 24. In at least one embodiment, the vacuum 34 may be attached to the floating head 24. The vacuum 34 may be any vacuum system capable of withdrawing the floating contaminants in the fluid contained in the clarification tank 12. In at least one embodiment, the vacuum 34 may be configured to remove contaminants from a trough into which contaminants may be disposed by the rake arm 30.

As shown in FIG. 1, a saturator 36 may be positioned upstream of the clarification tank 12. The saturator 36 may be used for mixing ionized gases or disinfectants, or both, with fluids entering the clarification tank 12 or recirculating through the recirculation loop 66. The ionized gas may be received from an ionized gas generator 37 or other appropriate source. In at least one embodiment, the saturator 36 may be formed from one or more chambers. The saturator 36 may be a pressure vessel operating between about three bars and about six bars in which one or more gases may be dissolved into a fluid enabling the fluid to be supersaturated with ionized gas. In at least one embodiment, the saturator 36 may receive ionized gases from an ionized gas generator, not shown, or other appropriate source, and mix the ionized gas with the fluid flowing through the saturator 36 and into the clarification tank 12. The saturator 36 may also inject disinfectants, such as, but not limited to chlorine, bromine, ozone and other disinfectants into the fluid flowing through the saturator 36. The disinfectants may be received from a disinfectant generator, not shown, or other appropriate source. In embodiments, in which a saturator 36 is not used, ionized gas may be injected into bottom aspects of the clarification tank 12 directly.

The fluid clarification system 10 may also include one or more contact tanks 38 positioned downstream of the clarification tank 12. The contact tank 38 increases the amount of time that a fluid remains in the system 10 before being exhausted. The contact tank 38 may be configured to inject one or more disinfectants into the fluid passing through the contact tank 38 depending on the type of contaminants present in the fluid. The disinfectants may be ozone, chlorine, hydrogen peroxide, or a catalyst to combine with the ionized gas and create mixed oxidants and an advanced oxidation process utilizing the ionized gas as one of the elements.

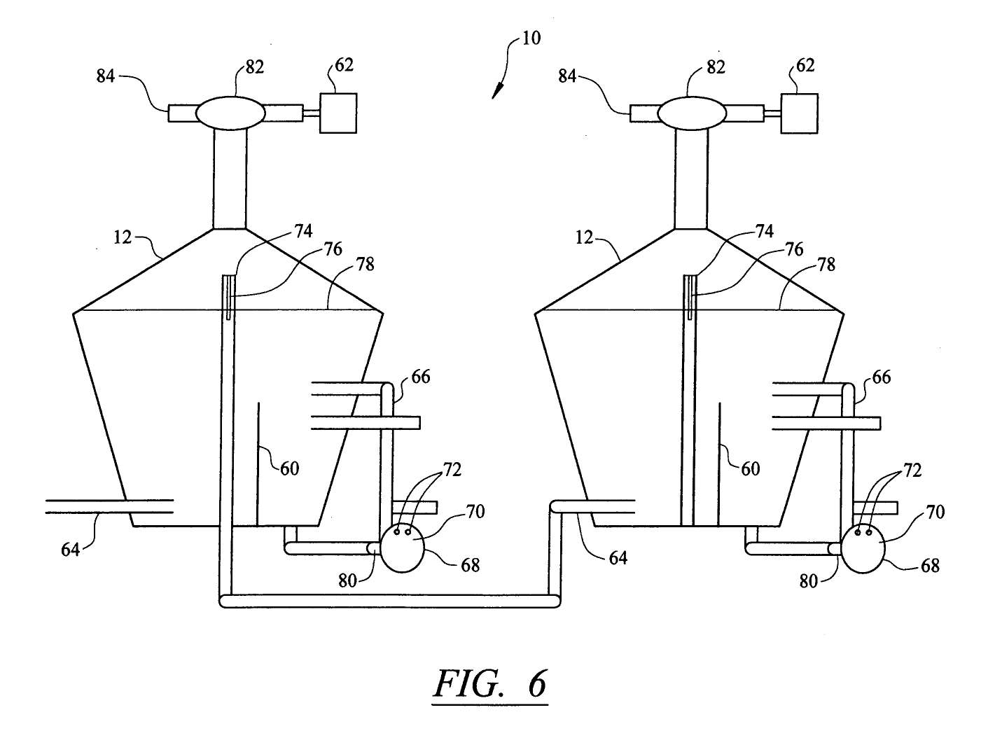

In an alternative embodiment, as shown in FIG. 6, the fluid clarification system 10 may include a clarification tank 12 having a sealed lid, which may be, but is not limited to being, a domed shaped lid. The clarification tank 12 may include a baffle 60 for limiting movement of the fluids within the clarification tank 12. The clarification tank 12 may include a vacuum system 62 for removing contaminants at the surface of the fluids contained in the clarification tank 12. The vacuum system 62 may operate by removing air from the uppermost portions of the tank 12. Fluids are drawn into the clarification tank 12 through an inlet 64, which causes the fluid level in the tank 12 to rise. The increased fluid volume in the tank 12 causes the contaminants to rise in the tank 12 and move into a position to be removed by the vacuum system 62 through valve 82. The fluid contained in the clarification tank 12 may return to a normal operating level by opening vent 84. The movement of fluid may be controlled with outlet port 19.

The clarification tank 12 may include a standpipe 74 with at least one aperture 76, which may be, but is not limited being, an adjustable level device, such as a slot, for controlling the surface level 78 of the fluids in the tank 12. The standpipe 74 and adjustable level device 76 also prevent fluids contained in the tank 12 from passing through the tank 12 at too fast a rate during heavy sea conditions when fluids in the tank 12 are being tossed within the tank 12. The height and size of the standpipe 74 and the size and quantity of the adjustable level device 76 are dependent upon the application.

The alternative configuration may also include a recirculation loop 66 for recirculating effluent that does not meet a contaminant threshold through the saturizor 36 for injection of ionized gases. The recirculation loop 66 may inject air into the fluids flowing through the loop 66 for some waste streams. In at least one embodiment, the ionized gas may be injected into the fluid at a pressure of about 90 pounds per square inch (psi), which may be developed by a pump 80. The recirculation loop 66 may include a tank 68. The tank 68, and the fluid clarification system 10, may be designed in accordance with the American Society for Testing and Materials (ASTM); Designation: F 2363-04, Standard Specification for United States Coast Guard Type II or IMO MARPOL 73/78 Annex IV Marine Sanitation Devices (Flow Through Treatment). For instance, the tank 68 may include a plate 70 with one or more holes 72 that prevent premature pass through of fluids through the tank 68 due to rough sea conditions. The holes 72 replace conventional weirs, which do not have the ability to prevent premature pass through if the tank 68 is tilted. The plate 70 and holes 72 enables the tank 68 to be operated for eight hours. During this eight hour period, one hour of operation is while the tank 68 is tipped between a twenty degree angle in a first direction and a twenty degree angle in a second direction. The process is required to be repeated with the tank 68 rotated 90 degrees. This testing process is designed to ensure that a system will function while on board a vessel in heavy seas. The holes 72 may be configured to prevent passage of too much fluids into the plate 70 during heavy sea conditions. Thus, the holes 72 control the flow of fluids out of the tank 68.

The fluid clarification system 10 may be sized to accommodate a particular flow rate. In at least one embodiment, the fluid clarification system 10 may be sized such that a single clarification tank 12 may accommodate a single flow rate. In another embodiment, the fluid clarification system 10 may be formed from a plurality of clarification tanks 12 coupled together in series or in parallel. Use of a plurality of clarification tanks 12 rather than a single, larger clarification tank may be particularly desirable for use in vessels where limited floor space is available and positioning multiple units of smaller size is desirable and advantageous relative to use of a larger single unit. Some of the components, such as the recycle pump, may be sized larger and used for each tank 12 to increase efficiency and reduce costs.

During operation, contaminant laden fluids may be passed into the fluid clarification system 10. The fluid may first be passed through the saturator 36 where ionized gases may be injected into the fluid. The ionized gas is injected under pressure into the contaminant laden fluid. The fluid then flows into the clarification tank 12 through the inlet port 18. As the fluid flows into the clarification tank 12, the fluid is released from a pressurized environment. As a result, the supersaturated ionized gas in the fluid forms numerous microbubbles. The microbubbles rise to the upper surface of the fluid contained in the clarification tank 12 and collect suspended solids in the fluid while passing through the fluid. The suspended solids rise through the fluid and collect on the upper surface of the fluid contained in the clarification tank 12. The rake arm 30 removes the floating contaminants from the fluids by withdrawing the solids using the vacuum 34. The floating contaminants are pulled through the orifices 32 in the rake arm 30 and removed from the clarification tank 12. The contaminants may be disposed of in numerous manners. Fluids having contaminants removed may be withdrawn from the tank 12 through the outlet 19.

The pH of the fluid in the clarification tank 12 may be regulated to be substantially neutral in at least one embodiment. In addition, flocculants or coagulants, or both, may be injected into the fluid in the clarification tank 12 to facilitate removal of contaminants from the fluid. Addition of the flocculants or coagulants into the clarification tank 12 is determined based on the type of contaminants contained in the contaminant laden fluid. Chlorine, or other contaminants, may also be injected directly into the fluid in the clarification tank to further increase the clarification tank's ability to remove contaminants from the fluid. In at least one embodiment, an electrocoagulator, or other appropriate device, may be used to coagulate and generate flocculants.

The fluid clarification system 10 is particularly suited to use on a vessel, such as, but not limited to a ship, a yacht, or other vessel. When the vessel is exposed to wave action, the floating head and rake, which is attached to the head, tilt with the vessel's movements. By tilting, the head 24 maintains its function as a cover on the fluid contained in the clarification tank 12. In addition, the rake arm 30 remains generally at the upper surface of the fluid contained in the clarification tank 12 and in a position to collect the contaminants from the upper surface of the fluid.

In another embodiment, the vacuum system 62 and the tank 68 with fluid flow limiting plate 70 and holes 72 facilitate operation of the fluid clarification system 10 on board a vessel. The tank 12 includes a domed lid for preventing fluids from splashing out of the system 10. In addition, the system 10 includes a vacuum system 62 for removing contaminants from the system 10 that is capable of operating in heavy sea conditions. The vacuum system 62 eliminates moving parts positioned within the tank 68, thereby reducing the likelihood of failure of the system and increasing the reliability.

The terms and expressions which have been employed herein are used as terms of description and not of limitation, and there is no intention, in the use of such terms and expressions, of excluding any equivalents of the features shown and described or portions thereof. Having thus described the invention in detail, it should be apparent that various modifications can be made in the present invention without departing from the spirit and scope of the following claims.

1. A dissolved air flotation system, comprising:
at least one clarification tank adapted to contain a fluid having suspended solids;
at least one inlet adapted to inject at least one gas and the fluid into the at least one clarification tank;
at least one outlet adapted to withdraw fluid from the at least one clarification tank; and
at least one ionized gas injector adapted to inject ionized gas into the fluid flowing through the at least one inlet.

2. The dissolved air flotation system of claim 1, further comprising at least one recirculation loop coupled to a saturizor having ionized gas injection.

3. The dissolved air flotation system of claim 1, further comprising at least one standpipe positioned in the at least one clarification tank and coupled to the at least one outlet.

4. The dissolved air flotation system of claim 3, further comprising an aperture positioned in the standpipe to regulate flow of fluids into the standpipe and out of the at least one outlet.

5. The dissolved air flotation system of claim 1, wherein the at least one clarification tank comprises a plurality of clarification tanks coupled together.

6. The dissolved air flotation system of claim 1, further comprising a vacuum system for drawing contaminants from an upper surface of a fluid contained in the at least one clarification tank.

7. A method of removing contaminants from a fluid, comprising:
injecting a fluid having at least one contaminant into at least one clarification tank having at least one outlet and at least one inlet;
injecting at least one ionized gas into the fluid contained in the at least one clarification tank causing a plurality of bubbles of ionized gas to form in the fluid, wherein the bubbles of ionized gas rise through the fluid causing at least a portion of the contaminants and float to an upper surface of the fluid contained in the at least one clarification tank;
withdrawing fluid from the outlet of the at least one clarification tank; and
withdrawing contaminants from the upper surface of the fluid.

8. The method of claim 7, wherein injecting at least one ionized gas into the fluid comprises injecting the at least one ionized gas into the fluid upstream of the at least one clarification tank in a saturator operating under a pressure greater than atmospheric pressure.

9. The method of claim 8, wherein the saturator is operating at a pressure between about three bars of atmospheric pressure and about six bars of atmospheric pressure.

10. The method of claim 7, further comprising injecting chlorine into the fluid in the at least one clarification tank.

11. The method of claim 7, further comprising maintaining the pH of the fluid at substantially neutral.

12. The method of claim 7, further comprising injecting flocculants into the fluid.

13. The method of claim 7, further comprising injecting coagulants into the fluid.

14. The method of claim 7, wherein withdrawing contaminants from the upper surface of the fluid comprises withdrawing contaminants using a vacuum system coupled to a rotatable floating rake.

15. A fluid clarification device, comprising:
at least one clarification tank for containing a fluid having suspended solids;
at least one inlet for injecting at least one gas and the fluid into the at least one clarification tank;
at least one outlet for withdrawing fluid from the at least one clarification tank; and
a vacuum for drawing contaminants from the upper surface of the fluid.

16. The fluid clarification system of claim 15, further comprising a floating head slidably attached to the at least one clarification tank enabling the floating head to move generally along a longitudinal axis of the clarification tank to float on an upper surface of a fluid contained in the at least one clarification tank.

17. The fluid clarification system of claim 16, wherein the floating head is capable of rotating up to about 15 degrees relative to the longitudinal axis of the clarification tank.

18. The fluid clarification device of claim 16, further comprising a plurality of wheels attached to the floating head for guiding the floating head up and down along the longitudinal axis.

19. The fluid clarification device of claim 15, further comprising a saturator in fluid communication with the at least one at least one clarification tank and upstream of the inlet, wherein the saturator is configured to inject ionized gas into a fluid at a pressure greater than atmospheric pressure.

20. The fluid clarification device of claim 15, further comprising at least one contact tank downstream of the at least one outlet for contacting the fluid with disinfectants.

21. The fluid clarification device of claim 15, further comprising at least one baffle positioned in the clarification tank above the inlet for diffusing bubbles across the cross-section of the clarification tank.
